(19) United States
(12) Patent Application Publication
(10) Pub. No.: US 2012/0219292 A1
(43) Pub. Date: Aug. 30, 2012

(54) OPTICAL SWITCH FOR IMPLEMENTING WAVE DIVISION MULTIPLEXING NETWORKS

(75) Inventors: David Jeffrey Graham, Sewickley, PA (US); David Markham Drury, Pittsburgh, PA (US); Eric John Helmsen, Wexford, PA (US)

(73) Assignee: ACCIPITER SYSTEMS, INC., Pittsburgh, PA (US)

(21) Appl. No.: 13/035,045

(22) Filed: Feb. 25, 2011

(51) Int. Cl. H04J 14/02; H04J 14/00

(52) U.S. Cl. 398/48; 398/45

(57) ABSTRACT

Systems and methods for switching optical signals are disclosed. A switch may include a plurality of inputs, at least one coupling element operably connected to two or more of the plurality of inputs and a splitting element operably connected to the at least one coupling element. Each of the plurality of inputs may receive one of a plurality of input signals. The at least one coupling element may be configured to combine at least two of the input signals into a combined output signal. The splitting element may be configured to demultiplex the combined output signal to produce a plurality of demultiplexed output signals.

### BACKGROUND

The disclosed embodiments generally relate to the fields of optical networks, data switching and data routing. More specifically, the disclosed embodiments generally relate to a passive optical switch for switching incoming data to a specific output.

Recently, telecommunication systems and data networking systems have rapidly grown in speed and capacity. Accompanying the growth of these systems, however, has been the cost of maintaining these systems. A typical network, such as a local area network (LAN), requires a large and costly infrastructure. For example, groups of servers must be included in the LAN to handle requests from users of the LAN, direct these requests accordingly, maintain various shared files and other resources, and provide a gateway to other networks, e.g., the Internet. In addition to the servers, each LAN must have a series of routers and switches to direct traffic generated by the users of the LAN. The servers, switches and routers, as well as the users' computers must all be connected via cabling or a wireless connection. These various devices and connections all require significant power, cooling, space and financial resources to ensure proper functionality.

Fiber optic cables have been used to replace standard coaxial or copper based connections in communication networks. Fiber optic cables typically use glass or plastic optical fibers to propagate light through a network. Specialized transmitters and receivers utilize the propagated light to send data through the fiber optic cables from one device to another. Fiber optic cables are especially advantageous for long-distance communications, because light propagates through the fibers with little attenuation as compared to electrical cables. This allows long distances to be spanned with few repeaters, thereby reducing the cost of a communication network.

In fiber-optic communications, wavelength-division multiplexing (WDM) is a technology that multiplexes multiple optical carrier signals on a single optical fiber by using different wavelengths of light to carry different signals. WDM allows for a multiplication in capacity.

A WDM system typically uses a multiplexer to join multiple optical carrier signals together at a transmitter, and a demultiplexer at the receiver to split the multiplexed signal into its original optical carrier signals. WDM systems are generally broken into three different wavelength patterns: conventional, coarse and dense.

Conventional WDM systems employ channel spacing on the order of 400 MHz and typically use wavelengths in the “C” band between 1530 and 1560 nm (see Table 1 below). The channel spacing, however, restricted the number of multiplexed wavelengths to between 8 and 16.

Dense Wave Division Multiplexing (DWDM) also refers to optical signals multiplexed within the 1530-1565 nm band, but with much closer channel spacing and, therefore, the ability to multiplex additional optical channels. 50 GHz channel spacing, resulting in 80 channels in the “C” band, is common for DWDM systems, with some DWDM systems supporting alternative channel spacing such as 25 GHz.

Alternatively, coarse WDM systems use the entire frequency band from 1310 to 1550 nm with increased channel spacing, thereby resulting in lower cost and less sophisticated transceiver designs.

Table 1 provides a list of band designations specified by the International Telecommunication Union for the main transmission regions of fiber optic cables and the wavelength ranges covered by each transmission region. Typically, DWDM falls into the 1530-1565 nm range, however, advances in materials and construction methods for optical fibers has increased this range to nearly the entire range of main transmission regions, i.e., 1260-1625 nm.

TABLE 1
ITU Standard Optical Band Definitions

| Band | Descriptor | Wavelength Range |
|---|---|---|
| O band | Original | 1260-1360 nm |
| E band | Extended | 1360-1460 nm |
| S band | Short Wavelength | 1460-1530 nm |
| C band | Conventional | 1530-1565 nm |
| L band | Long Wavelength | 1565-1625 nm |
| U band | Ultralong Wavelength | 1625-1675 nm |

Conventional optical modulation schemes are based on Non-Return-to-Zero (NRZ) algorithms, which deliver 1 bit per Hz used. In an NRZ algorithm based modulation scheme, the value “1” is represented by a first significant condition (e.g., a presence of light or an optical signal), and the value “0” is represented by a second significant condition (e.g., an absence of light or an optical signal). As an NRZ algorithm based modulation scheme has no rest or neutral position between bits, the bandwidth used is significantly reduced.

As both communication systems grow and fiber optic systems become more integrated into standard communications, the speed, and resultant cost, of individual network components is also growing. Huge investments must be made by telecommunication companies to keep up with consumer demand as well as technological developments. As a result, telecommunication companies as well as businesses running their own communication networks would benefit greatly from network components with reduced space, weight, cost and power requirements. However, development has progressed slowly in this area. Instead, network components are simply made bigger and heavier, and consume more power in the pursuit of supplying higher bandwidth.

In atypical environments, such as airborne or shipborne networks, space, weight and power become even more important for network design. However, the lack of progress in reducing the space, weight and power of network components described above has restricted the availability of high-bandwidth networks in such environments.

For example, space is at a premium on most airplanes and smaller ships. As such, network components of the size used in most business environments could exceed the available storage space in such environments. Data networks capable of providing on-demand video and audio programming to airplane passengers have developed slowly at least because of the size of conventional networking equipment. Similarly, military aircraft often require high-speed communication between subsystems or are used as a flying communication hub. However, conventional networking equipment is limited in its ability to perform this task because of the limited footprint that can be provided to all functions in an aircraft.

In addition, the weight of a network component has a direct effect on fuel consumption in airborne or shipborne environments as well since the added weight increases the drag on the airplane or ship. Similarly, the amount of power consumed by network components directly affects fuel consumption since power in airborne and shipborne environments is generated within the environment itself. For ships that are at sea for long periods of time, the power consumed by conventional networking equipment inhibits the ability to use such equipment because of the drain on limited energy reserves.

One approach at reducing the number of network components has been to implement a ring topology. For example, U.S. patent application Ser. No. 12/477,576 filed Jun. 3, 2009 and entitled “Optical Network Systems and Methods for Operating Same,” the content of which is hereby incorporated herein in its entirety, teaches such a ring topology. However, this specific implementation uses each node in the network as a link in the ring, and as such, if any node is removed or otherwise becomes unusable, the network may fail.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a switch for switching optical signals including a plurality of inputs, wherein each of the plurality of inputs receives one of a plurality of input signals, at least one coupling element operably connected to two or more of the plurality of inputs and configured to combine at least two of the input signals into a combined output signal, and a splitting element operably connected to the at least one coupling element and configured to demultiplex the combined output signal to produce a plurality of demultiplexed output signals.

In another general respect, the embodiments disclose a switch for switching optical signals including a plurality of ports that each include an input and an output, at least one coupling element operably connected to a plurality of the inputs and configured to combine a plurality of input signals into a combined output signal, and a splitting element operably connected to the at least one coupling element and configured to demultiplex the combined output signal to produce a plurality of demultiplexed output signals and direct one of the demultiplexed output signals to at least one output.

In yet another general respect, the embodiments disclose an optical network including a plurality of nodes, and a switch operably connected to each of the plurality of nodes via at least one optic fiber. The switch includes a plurality of inputs, wherein each of the plurality of inputs receives one of a plurality of input signals, at least one coupling element operably connected to two or more of the plurality of inputs and configured to combine at least two of the input signals into a combined output signal, and a splitting element operably connected to the at least one coupling element and configured to demultiplex the combined output signal to produce a plurality of demultiplexed output signals.

### BRIEF DESCRIPTION OF THE DRAWINGS

FIG. 1 illustrates an exemplary optical network according to an embodiment.

FIG. 2 illustrates an exemplary switch for use in the network of FIG. 1 according to an embodiment.

FIG. 3 illustrates an alternative switch according to an embodiment.

FIG. 4 illustrates an alternative switch according to an embodiment.

### DETAILED DESCRIPTION

The following terms shall have, for the purposes of this application, the respective meanings set forth below.

A “node” refers to a processor-based system configured to transmit and receive information from one or more other nodes via a network. For example, a node may transmit to one or more destination nodes by varying the frequency of its transmissions to match a frequency at which a particular destination node receives packets.

A “switch” refers to a network component that provides bridging and/or switching functionality between a plurality of nodes. A switch may have a plurality of inputs and a corresponding number of outputs. Each node may be operably connected to a switch via both an input fiber and an output fiber.

Terabit Optical Ethernet (“TOE”) is a network architecture and transmission protocol that may be used to implement local, wide and/or metropolitan area networks. An exemplary TOE may be found in U.S. Pat. No. 7,751,709 filed Jan. 18, 2006 and entitled “Method and System for Interconnecting End Systems over an Optical Network,” the contents of which are hereby incorporated by reference. TOE may transmit 100s of terabits of information per second over single mode fibers that are common today. TOE is a highly scalable architecture allowing controlled access to a common shared fiber media.

Using TOE, an end system and/or an end system concentrator may directly access the shared media and may communicate with all other systems and/or concentrators throughout the system. Thousands of end nodes and/or end node concentrators may be supported with a total throughput exceeding 100 Tbps. In addition, the shared media utilized by TOE may replace the huge investment required for physical infrastructure as a result of link/switch architectures common in conventional networks.

TOE resolves these problems by permitting a dramatic reduction in capital expenditure because most system elements are replaced by the fiber. Moreover, power, cooling and housing costs are dramatically reduced as a result of the reduction in physical infrastructure. In addition, TOE is easily scalable and can benefit from increases in optical technologies for improved bandwidth over time. TOE may be designed to carry Ethernet traffic by providing Ethernet interfaces to connected computer systems. Although current technologies are limited to 10 Gbps Ethernet systems, advances in the future may be readily accommodated by TOE. TOE, and methods of using TOE to reduce network costs by interfacing various computer systems via an optical switch are discussed below with reference to the figures.

An exemplary TOE network as discussed herein may include at least three basic elements: a plurality of nodes, at least one switching device and an optical fiber. Each node may include one or more transceivers used to access the optical fiber. An optical transceiver may be an integrated circuit configured to transmit and receive a signal via an optical fiber. An optical fiber is typically a glass or plastic tube configured to carry an optical signal. In the exemplary TOE network as discussed herein, an optical fiber may be used to link each node to the switching device, thereby establishing a network, such as a LAN.

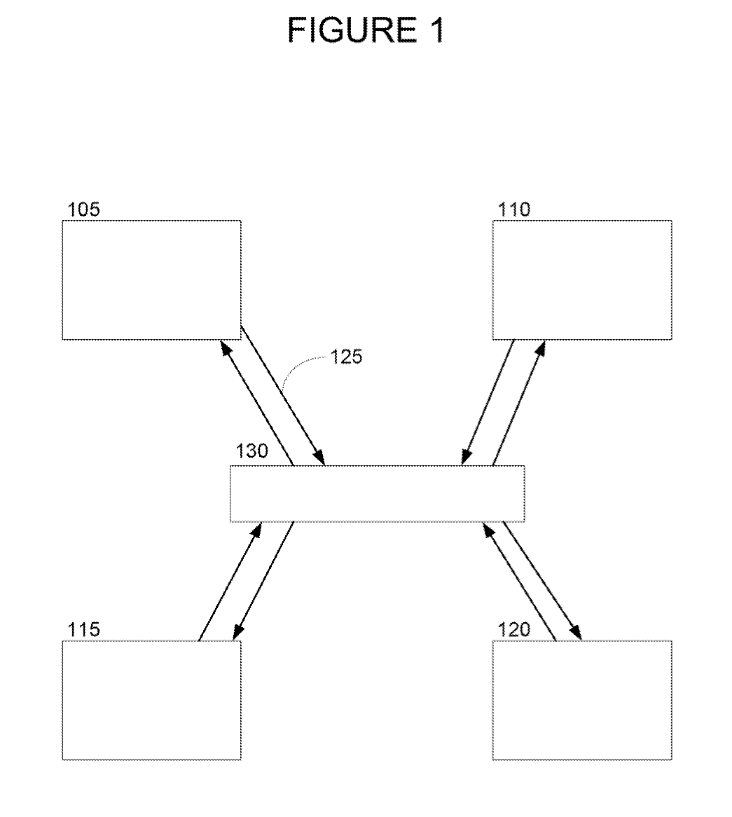

FIG. 1 illustrates a system level diagram of an exemplary TOE network 100. TOE network 100 may include four nodes 105, 110, 115 and 120 interconnected by a series of optical fibers 125 to a passive switch 130. Each node may be connected to both an input terminal and an output terminal of the switch 130. Each node may also be associated with a specific wavelength. The wavelength for each node may be used by each of the other nodes and the switch in concert such that traffic or data packets are correctly switched to the appropriate destination. For example, in TOE network 100, node 105 may be associated with wavelength A, node 110 may be associated with wavelength B, node 115 may be associated with wavelength C and node 120 may be associated with wavelength D. In one embodiment, TOE nodes may be associated with wavelengths in the infrared spectrum. However, other wavelengths may also be used as will be apparent based on the teachings of the present disclosure.

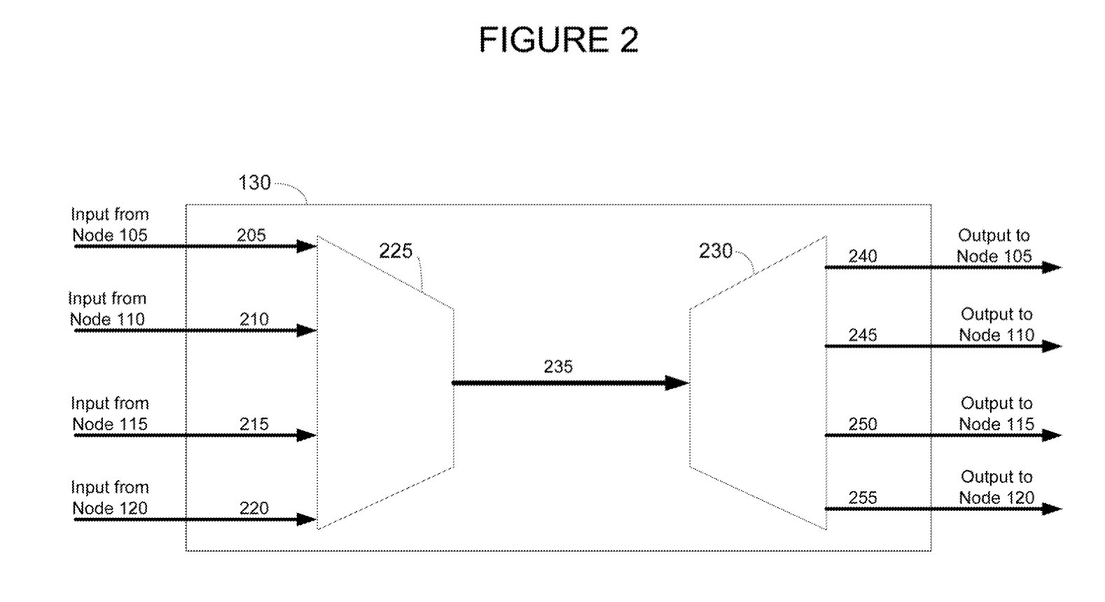

In order for one node to transmit data to another node, the node must label the data with the wavelength associated with the required destination. For example, node 105 may send a packet intended for node 120 at wavelength D. The node 105 may transmit the packet to switch 130. The switch 130 may receive the packet and output the packet to node 120 accordingly. The internal architecture of the switch 130 is discussed in greater detail below with respect to FIGS. 2-4.

In order to support transmissions at multiple wavelengths, each node may be able to change the wavelength at which it transmits on a packet-by-packet basis. Exemplary systems for transmitting using multiple wavelengths include electronically tunable lasers or systems using multiple lasers at each node.

FIG. 2 illustrates an exemplary architecture for the switch 130. The switch 130 may be a passive switch in that it includes no power supply. Rather, the switch 130 includes an arrangement of components that utilize the inherent properties of an optic signal to achieve switching without any additional power requirements.

The switch 130 may include a plurality of inputs 205, 210, 215 and 220, each of which is associated with one of nodes 105, 110, 115 and 120, respectively. Each of the inputs may be operably connected via an optic fiber to a first stage of the switch 130. The first stage may be arranged such that all incoming signals received via any of the inputs 205, 210, 215 and 220 are multiplexed via a joining function or joining element and are output via a single optic fiber. Exemplary joining elements may include optical combiners, optical couplers, and other similar devices configured to multiplex a plurality of optical input signals into a single optical output signal. As shown in FIG. 2, the exemplary switch 130 may include a combiner 225. The combiner 225 may be configured such that each of inputs 205, 210, 215 and 220 is combined or multiplexed into a single output signal 235. In this example, the first stage output is a single WDM signal 235 comprising each of the inputs 205, 210, 215 and 220.

The WDM output signal 235 may be directed via an optic fiber to a splitting function or splitting element. The splitting elements may be arranged and configured such that the WDM output signal 235 is demultiplexed into individual signal components. Examples of splitting elements may include an arrayed waveguide grating (AWG), an optical splitter, and other similar devices configured to demultiplex an optical signal, such as WDM output signal 235, into one or more output components. As shown in FIG. 2, the exemplary switch 130 may include an AWG 230. The AWG 230 may be configured such that it operates as an optical demultiplexer by receiving the WDM output signal 235, demultiplexing the signal into its individual components, each having an associated wavelength, and directing each individual signal component to an appropriate output 240, 245, 250 or 255 based upon its associated wavelength.

For example, node 105 may have a series of packets to send to node 120. The node 105 transmits the series of packets to the switch 130 at wavelength D, i.e., the wavelength associated with node 120. The combiner 225 receives the series of packets from node 105 via input 205, and multiplexes the series of packets along with any other incoming data from inputs 210, 215 and 220 into a single WDM output signal 235. The AWG 230 receives the WDM output signal 235 comprising the series of packets intended for node 120. The AWG may demultiplex the WDM output signal 235 into its individual components. Any signal components having wavelength A (i.e., intended for node 105) are transmitted to node 105 via output 240, any signal components having wavelength B (i.e., intended for node 110) are transmitted to node 110 via output 245, any signal components having wavelength C (i.e., intended for node 115) are transmitted to node 115 via output 250, and any components having wavelength D (i.e., intended for node 120) such as the series of packets are transmitted to node 120 via output 255.

In order to achieve such a demultiplexing, the AWG 230 may be configured or tuned to output via a set of specific wavelengths. For example, each output of the AWG 230 may be a particular number of nanometers apart. For example, if the AWG 230 is configured to operate on the C band, each of the outputs may be assigned to wavelengths that are 5 nm apart. Furthering the example above, wavelength A may be 1530 nm, wavelength B may be 1535 nm, wavelength C may be 1540 nm, and wavelength D may be 1545 nm. The AWG 230 may be configured or tuned accordingly such that the output 240 corresponds to 1530 nm, the output 245 corresponds to 1535 nm, the output 250 corresponds to 1540 nm, and the output 255 corresponds to 1545 nm. Thus, each individual signal component of WDM output signal 235 corresponding to those specific wavelengths is directed by AWG 230 to the appropriate output. Alternative methods of assigning the outputs of the AWG, such as by differences in frequency, may also be performed within the scope of this disclosure.

Each node operably connected to the switch 130 therefore has an associated port that includes an input connection and an output connection. The output connection is associated with the specific wavelength (or frequency) assigned to that node. In the exemplary embodiment illustrated in FIGS. 1 and 2, node 105 has a port including input 205 and output 240, node 110 has a port including input 210 and output 245, node 115 has a port including input 215 and output 250, and node 120 has a port including input 220 and output 255.

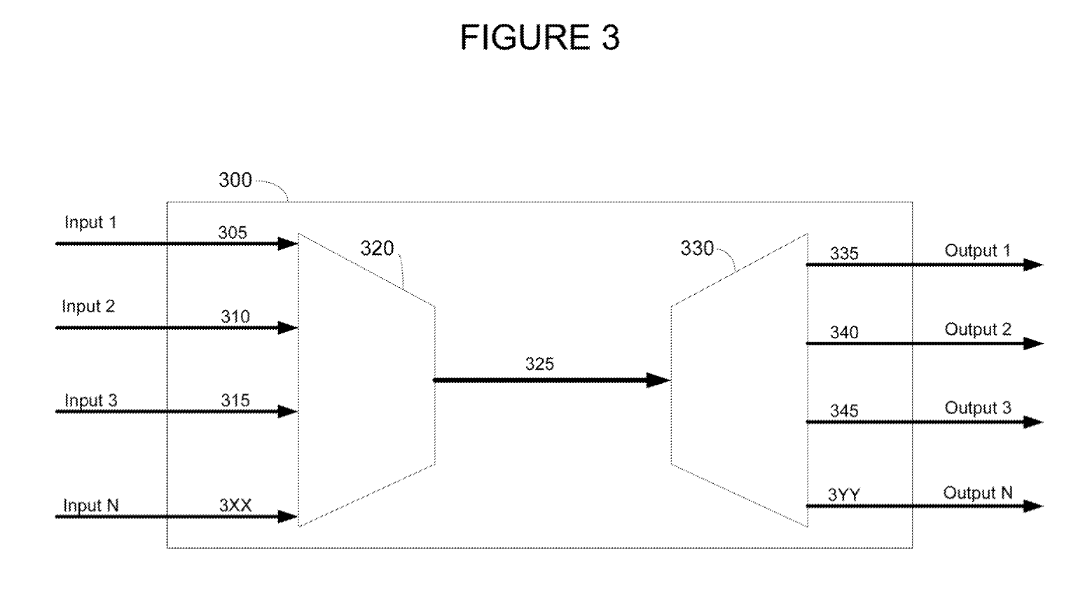

It should be noted the arrangement and architecture of switch 130 as shown in FIG. 2 is shown by way of example only. The switch may be scaled accordingly to handle a larger number of inputs and outputs. For example, as shown in FIG. 3, a switch 300 may include inputs from nodes 1, 2, 3, . . . , N received via inputs 305, 310, 315, . . . , 3XX. Each of the inputs may be combined in an N:1 combiner 320. A WDM output signal 325 may be passed to a 1:N AWG 330, where the output signal is split into N components and switched to nodes 1, 2, 3, . . . , N via outputs 335, 340, 345, . . . , 3YY.

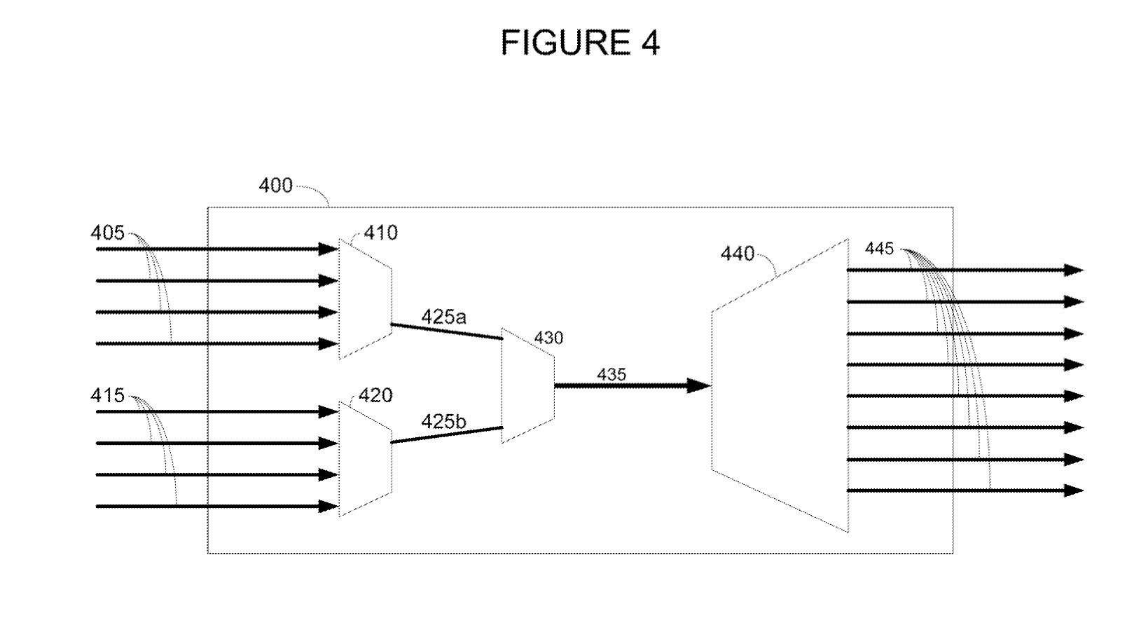

Similarly, as shown in FIG. 4, a switch 400 may be scaled to include multiple levels of combiners. For example, a plurality of inputs 405 may be combined by first combiner 410 resulting in a first WDM output 425a and a second plurality of inputs 415 may be combined by a second combiner 420 resulting in a second WDM output 425b. The first WDM output 425a and the second WDM output 425b may be combined by a third combiner 430 to form a single WDM output signal 435. The WDM output signal 435 is passed to an AWG 440 where the WDM output signal is demultiplexed into a plurality of individual components having unique wavelengths, each of which is output via one of a plurality of outputs 445. It should be noted that two combiners 410 and 420 are shown by way of example only. Additional combiners may be used, the outputs of which may be directed to the third combiner 430. Similarly, an additional level of combiners may be used depending on the number of inputs and the multiplexing capabilities of the individual combining elements.

It should be noted that the switches as shown in FIGS. 2-4 may be modified accordingly based upon the requirements of a network the switches are integrated into. Additionally, the switches may be modified accordingly to compensate for any losses in signal quality associated with the individual components used to construct the switch. For example, the switch 400 may further include an amplifier for increasing the output power of each of the outputs 445. In such an embodiment, the switch may further require a power source in order to provide power for the amplifier.

It should also be noted that while the disclosed embodiments refer to switch data operating over Ethernet, the switches may also be used with alternate and/or additional networking protocols. For example, a switch, such as switches 130, 300 and 400, may be integrated into an InfiniB and network, a Fibre Channel network, or another similar switched fabric network protocol configured to transfer data between nodes.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A switch for switching optical signals comprising:
a plurality of inputs, wherein each of the plurality of inputs receives one of a plurality of input signals;
at least one coupling element operably connected to two or more of the plurality of inputs and configured to combine at least two of the input signals into a combined output signal; and
a splitting element operably connected to the at least one coupling element and configured to demultiplex the combined output signal to produce a plurality of demultiplexed output signals.

2. The switch of claim 1, further comprising a plurality of outputs each operably connected to the splitting element and configured to receive at least one of the demultiplexed output signals.

3. The switch of claim 2, wherein each of the plurality of outputs has a unique associated wavelength.

4. The switch of claim 1, wherein the splitting element comprises an arrayed wavelength guide (AWG).

5. The switch of claim 4, wherein the AWG is tuned to direct each of the plurality of demultiplexed output signals signal to a specific output based upon the wavelength of each of the plurality of demultiplexed output signals.

6. The switch of claim 1, wherein the at least one coupling element comprises an optical combiner.

7. The switch of claim 1, wherein the switch is non-powered.

8. A switch for switching optical signals comprising:
a plurality of ports, each port comprising:
an input, and
an output;
at least one coupling element operably connected to a plurality of the inputs and configured to combine a plurality of input signals into a combined output signal; and
a splitting element operably connected to the at least one coupling element and configured to demultiplex the combined output signal to produce a plurality of demultiplexed output signals and direct one of the demultiplexed output signals to at least one output.

9. The switch of claim 8, wherein the splitting element comprises an arrayed wavelength guide (AWG).

10. The switch of claim 9, wherein the AWG is tuned to direct each of the demultiplexed output signals to a specific output based upon the wavelength of each demultiplexed output signal.

11. The switch of claim 8, wherein each output has a unique associated wavelength.

12. The switch of claim 8, wherein the coupling element comprises an optical combiner.

13. The switch of claim 8, wherein the switch is non-powered.

14. An optical network comprising:
a plurality of nodes; and
a switch operably connected to each of the plurality of nodes via at least one optic fiber and comprising:
a plurality of inputs, wherein each of the plurality of inputs receives one of a plurality of input signals,
at least one coupling element operably connected to two or more of the plurality of inputs and configured to combine at least two of the input signals into a combined output signal, and
a splitting element operably connected to the at least one coupling element and configured to demultiplex the combined output signal to produce a plurality of demultiplexed output signals.

15. The optical network of claim 14, further comprising a plurality of outputs each operably connected to the splitting element and configured to receive at least one of the demultiplexed output signals.

16. The optical network of claim 15, wherein each of the plurality of outputs has a unique associated wavelength.

17. The optical network of claim 14, wherein the splitting element comprises an arrayed wavelength guide (AWG).

18. The optical network of claim 17, wherein the AWG is tuned to direct each of the plurality of demultiplexed output signals signal to a specific output based upon the wavelength of each of the plurality of demultiplexed output signals.

19. The optical network of claim 14, wherein the coupling element comprises an optical combiner.

20. The optical network of claim 14, wherein the switch is non-powered.
